(19) United States
(12) Patent Application Publication
(10) Pub. No.: US 2026/0349409 A1
(43) Pub. Date: Nov. 5, 2026

(54) INTEGRATED THREE-DIMENSIONAL PRINTING, MATERIAL SELECTION, AND TREATMENT

(71) Applicant: International Business Machines Corporation, Armonk, NY (US)

(72) Inventors: Tushar AGRAWAL, West Fargo, ND (US); Sarbajit Kumar RAKSHIT, Kolkata (IN); Aaron Keith BAUGHMAN, Cary, NC (US); Carolina GARCIA DELGADO, Zapopan (MX)

(21) Appl. No.: 19/197,437

(22) Filed: May 2, 2025

(51) Int. Cl. G05B 19/4099

(52) U.S. Cl. CPC G05B 19/4099; G05B 2219/49023

(57) ABSTRACT

A three-dimensional (3D) model of an object and a set of environmental and operational parameters associated with the object may be received. A stress simulation may be performed on different portions of the object based on the environmental and operational parameters. One or more materials and one or more material treatments may be selected for the object based on results of the stress simulation. A 3D printing operation may be performed to 3D print the object from the one or more materials. The one or more material treatments may be performed on the object.

### BACKGROUND

This disclosure relates to three-dimensional (3D) printing, and more specifically, to integrated 3D printing, material, selection, and treatment.

### SUMMARY

Some aspects described herein relate to a method. The method may include receiving a 3D model of an object and a set of environmental and operational parameters associated with the object. The method may include performing a stress simulation on different portions of the object based on the environmental and operational parameters. The method may include selecting one or more materials and one or more material treatments for the object based on results of the stress simulation. The method may include performing a 3D printing operation to 3D print the object from the one or more materials. The method may include performing the one or more material treatments on the object.

Some aspects described herein relate to a computer system. The computer system may include a processor set, one or more computer-readable storage media, and program instructions stored on the one or more computer-readable storage media to cause the processor set to perform operations. The operations may include receiving a 3D model of an object to be 3D printed. The operations may include receiving a set of environmental and operational parameters for the object. The operations may include performing, based on the set of environmental and operational parameters, an iterative stress simulation on the object using a plurality of candidate materials and a plurality of candidate material treatments for the object. The operations may include selecting, based on the iterative stress simulation, a material for the object from the plurality of candidate materials. The operations may include selecting, based on the iterative stress simulation, a material treatment for the object from the plurality of candidate material treatments. The operations may include performing a 3D printing operation to 3D print the object from the material. The operations may include performing the material treatment on the object.

Some aspects described herein relate to a computer program product. The computer program product may include one or more computer-readable storage media and program instructions stored on the one or more computer-readable storage media to perform operations. The operations may include receiving a 3D model of an object to be 3D printed. The operations may include receiving a set of environmental and operational parameters for the object. The operations may include performing, based on the set of environmental and operational parameters, a first iterative simulation on the object using a plurality of candidate materials and a plurality of candidate material treatments for the object. The operations may include performing, based on the first iterative simulation, a second iterative simulation to select a material for the object from the plurality of candidate materials and a material treatment for the object from the plurality of candidate material treatments. The operations may include performing a 3D printing operation to 3D print the object from the material. The operations may include performing the material treatment on the object.

### BRIEF DESCRIPTION OF THE DRAWINGS

FIG. 1 is a diagram of an example computing environment for supporting 3D printing.

FIG. 2 is a diagram of an example implementation of a 3D printing system.

FIGS. 3A and 3B are diagrams of an example implementation of 3D printing an object.

FIG. 4 is a diagram of an example implementation of 3D printing an object.

FIG. 5 is a diagram of an example implementation of a 3D printing process for 3D printing an object.

FIG. 6 is a diagram of an example implementation of a long short-term memory model.

FIG. 7 is a flowchart of an example process associated with integrated 3D printing, material selection, and treatment.

FIG. 8 is a flowchart of an example process associated with integrated 3D printing, material selection, and treatment.

FIG. 9 is a flowchart of an example process associated with integrated 3D printing, material selection, and treatment.

### DETAILED DESCRIPTION

The following detailed description of example implementations refers to the accompanying drawings. The same reference numbers in different drawings may identify the same or similar elements.

Three-dimensional (3D) printing technology has become increasingly popular in various fields, including industrial manufacturing, aerospace, and healthcare. However, ensuring the durability and lifespan of a 3D printed object may be difficult, particularly for 3D printed objects that are exposed to harsh environmental and operational stresses. In some cases, a 3D printed object may be manufactured from a single material and material treatment that is used for the entire 3D printed object, regardless of the varying stresses that may be experienced in different regions of the 3D printed object. This can lead to weak points in the 3D printed object that are more prone to failure than other parts of the 3D printed object, which can reduce the performance, increase the wear and tear, and/or even lead to failure of the 3D printed object.

In some implementations described herein, a 3D printing system includes integrated 3D printing and material treatment capabilities that provide for optimizing material selection and treatment for 3D printed objects. For example, iterative simulations may be performed for various regions of a 3D printed object so that different regions of the 3D printed object may be manufactured from different materials and material treatments that are optimized for the types and magnitudes of stresses that are to be experienced in those regions. In this way, material selection for material treatment may be tailored to the specific stress profiles of the 3D printed object, which may increase the performance, decrease the wear and tear, and/or increase the life of the 3D printed object.

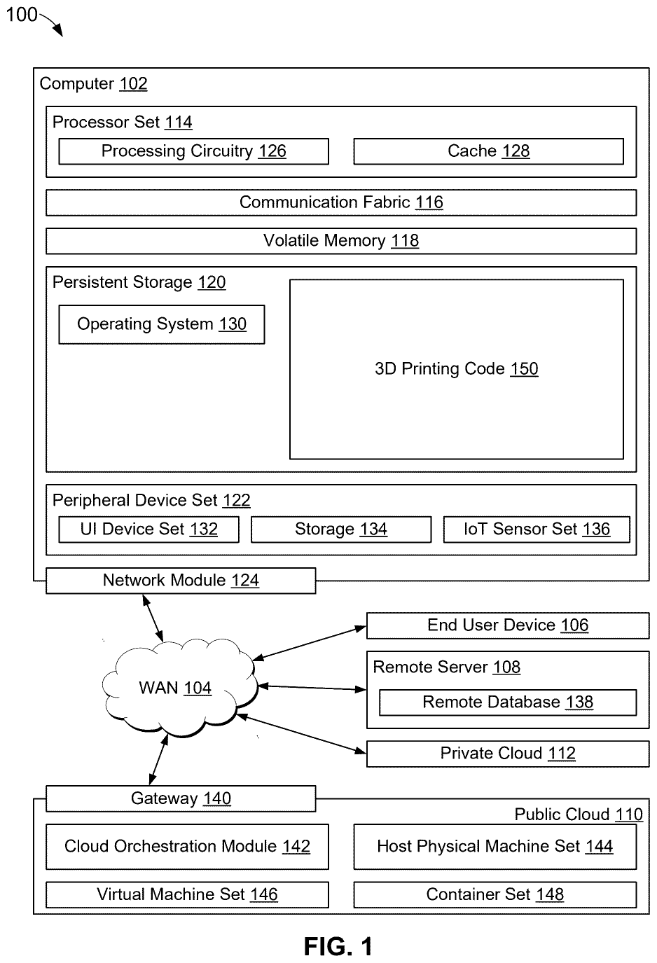

FIG. 1 is a diagram of an example computing environment 100 for supporting 3D printing.

The computing environment 100 contains an example of an environment for the execution of at least some of the computer code involved in performing the inventive methods, such as 3D printing code 150. In addition to the 3D printing code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the 3D printing code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in 3D printing code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the 3D printing code 150 typically includes at least some of the computer code involved in performing one or more operations described herein. In some implementations, the operations may include receiving a 3D model of an object and a set of environmental and operational parameters associated with the object; performing a stress simulation on different portions of the object based on the environmental and operational parameters; selecting one or more materials and one or more material treatments for the object based on results of the stress simulation; performing a 3D printing operation to 3D print the object from the one or more materials; and/or performing the one or more material treatments on the object.

In some implementations, the operations may include receiving a 3D model of an object to be 3D printed; receiving a set of environmental and operational parameters for the object; performing, based on the set of environmental and operational parameters, an iterative stress simulation on the object using a plurality of candidate materials and a plurality of candidate material treatments for the object; selecting, based on the iterative stress simulation, a material for the object from the plurality of candidate materials; selecting, based on the iterative stress simulation, a material treatment for the object from the plurality of candidate material treatments; performing a 3D printing operation to 3D print the object from the material; and/or performing the material treatment on the object.

In some implementations, the operations may include receiving a 3D model of an object to be 3D printed; receiving a set of environmental and operational parameters for the object; performing, based on the set of environmental and operational parameters, a first iterative simulation on the object using a plurality of candidate materials and a plurality of candidate material treatments for the object; performing, based on the first iterative simulation, a second iterative simulation to select a material for the object from the plurality of candidate materials and a material treatment for the object from the plurality of candidate material treatments; performing a 3D printing operation to 3D print the object from the material; and/ore performing the material treatment on the object.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

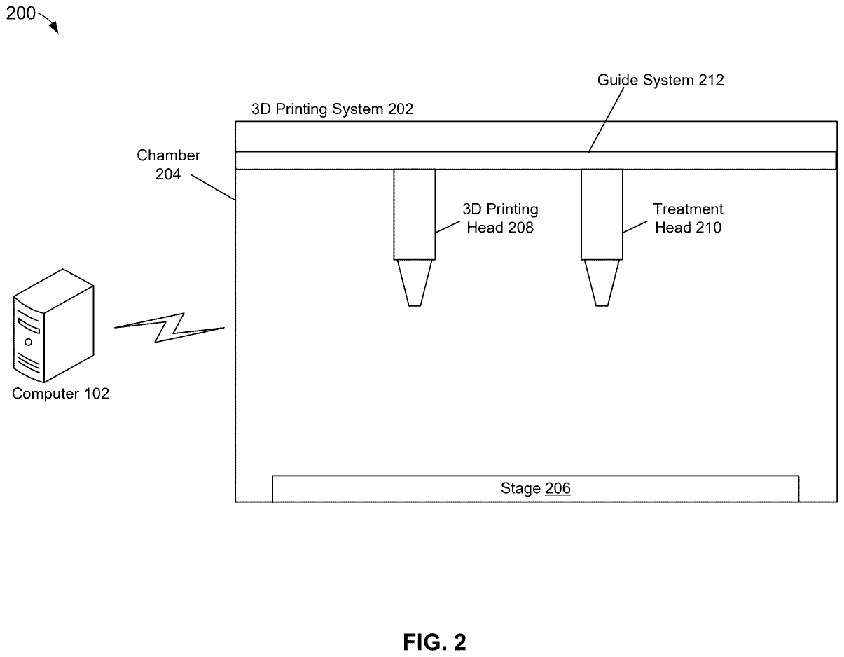

FIG. 2 is a diagram of an example implementation 200 of a 3D printing system 202. The 3D printing system 202 may be configured to 3D print objects using one or more 3D printing techniques, such as fused deposition, stereolithography, binder jetting, and/or powder bed fusion, among other examples. The objects that can be 3D printed by such a 3D printing system 202 are not limited to any particular type of object, and may include industrial components, consumer components, and/or other types of components.

As shown in FIG. 2, the 3D printing system 202 may include a chamber 204 and a stage 206 within the chamber 204. A plurality of types of heads and/or nozzles may be located within the chamber 204 above the stage 206, including a 3D printing head 208 and a treatment head 210. These components may be coupled to a guide system 212 that enables the 3D printing head 208 and/or the treatment head 210 to be moved and selectively positioned using computer numerical control (CNC).

The chamber 204 may include an internal volume and may include one or more sides that enclose the internal volume. Alternatively, one or more sides of the chamber 204 may be omitted such that the internal volume of the chamber is open and accessible.

In some implementations, the stage 206 includes a base plate, a chamber floor, a platen, and/or another type of horizontal surface that is configured to support and provide a substrate on which an object is 3D printed.

In some implementations, the stage 206 is a build platform that is surrounded by walls to define a volume in which a powder bed may be contained. A powder stock and powder roller may be located adjacent to the build platform and may be configured to provide additional layers of powder to the powder bed for 3D printing. The build platform may be configured to be raised and/or lowered as layers of an object are 3D printed.

In some implementations, the 3D printing head 208 is configured to provide the additive material for 3D printing an object. For example, the 3D printing head 208 may include a material jet, a material extrusion nozzle, and/or another type of head through which material is deposited onto the stage 206 (or onto an object that is being 3D printed on the stage 206).

In some implementations, the 3D printing head 208 is a fusion source that fuses material to an object that is being 3D printed. For example, the 3D printing head 208 may include a laser head that melts or sinters material of a powder bed on the stage 206 to fuse powder from the powder bed to the object being 3D printed. As another example, the 3D printing head 208 may include a laser head that cures a resin to solidify the resin to add material to an object being 3D printed.

The treatment head 210 may include one or more nozzles that are configured to perform one or more types of material treatments on objects that are 3D printed by the 3D printing head 208, such as flame hardening, annealing, quenching, tempering, normalizing, precipitation hardening, alloying, coating, plating, nitriding, oxidizing, cold rolling, cold drawing, case hardening, carburizing, nitrocarburizing, and/or welding, among other examples.

In some implementations, the treatment head 210 includes a flame hardening nozzle such as a torch that emits a flame for flame hardening a surface of an object that is being 3D printed. The flame emitted by the flame hardening nozzle may heat the surface of the object that is being 3D printed. The heat from the flame causes the surface of the object to reach a temperature above a temperature threshold associated with the material. For example, if the object is made of steel, the flame hardening nozzle may heat the surface of the object to (or greater than) a temperature of approximately 750 degrees Celsius to approximately 900 degrees Celsius to modify the crystal structure of the material of the object. However, other temperatures and temperature ranges for flame hardening of an object are within the scope of the present disclosure.

The treatment head 210 may also include a quenching nozzle through which a coolant is emitted to cool the surface of an object after a flame has been applied to the surface of the object using the flame hardening nozzle. The coolant may include water, oil, air, and/or another quenching medium. The quenching nozzle may rapidly cool the surface of the object, and the rapid cooling causes further modification of the crystal structure of the surface of the object for surface hardening.

In some implementations, the treatment head 210 includes a nozzle that deposits a coating onto an object that is and/or was 3D printed by the 3D printing head 208. Such coating may include an electroplated coating or electroless plated coating, a nitride coating, an oxide coating, and/or another type of coating.

The guide system 212 may include a combination of belts, gears, motors, structures, and/or other components that enable the 3D printing head 208 and/or the treatment head 210 to be moved according to a programmed path. In some implementations, the guide system 212 includes a gantry to which the 3D printing head 208 and/or the treatment head is mounted. The computer 102 may control the movement of the 3D printing head 208 and/or the treatment head 210 along the gantry by CNC programming.

As further shown in FIG. 2, the computer 102 may be communicatively coupled to the 3D printing system 202 and may control various aspects of the operation of the 3D printing system 202 and/or the components included therein. The computer 102 may be a part of the 3D printing system 202 and may correspond to the control system of the 3D printing system 202. In some implementations, the computer 102 is embedded in the form factor of the 3D printing system 202. In some implementations, the computer 102 is located remotely from the 3D printing system 202.

The computer 102 may communicate with components of the 3D printing system 202 over wired and/or wireless communication links using the network module 124 and/or the communication fabric 116, among other examples. The computer 102 may communicate with components of the 3D printing system 202 to control various aspects of the operation of the 3D printing system 202 to 3D print an object and/or to apply a surface treatment to the object. For example, various aspects of the 3D printing head 208 may be controllable by the computer 102. For example, the computer 102 may provide one or more signals to the 3D printing system 202 to cause the 3D printing head 208 to 3D print an object. As another example, various aspects of the treatment head 210 may be controllable by the computer 102. For example, the computer 102 may provide one or more signals to the 3D printing system 202 to cause the treatment head 210 to perform a particular type of surface treatment on an object.

FIG. 2 is provided as an example. Other examples may differ from what is described with regard to FIG. 2.

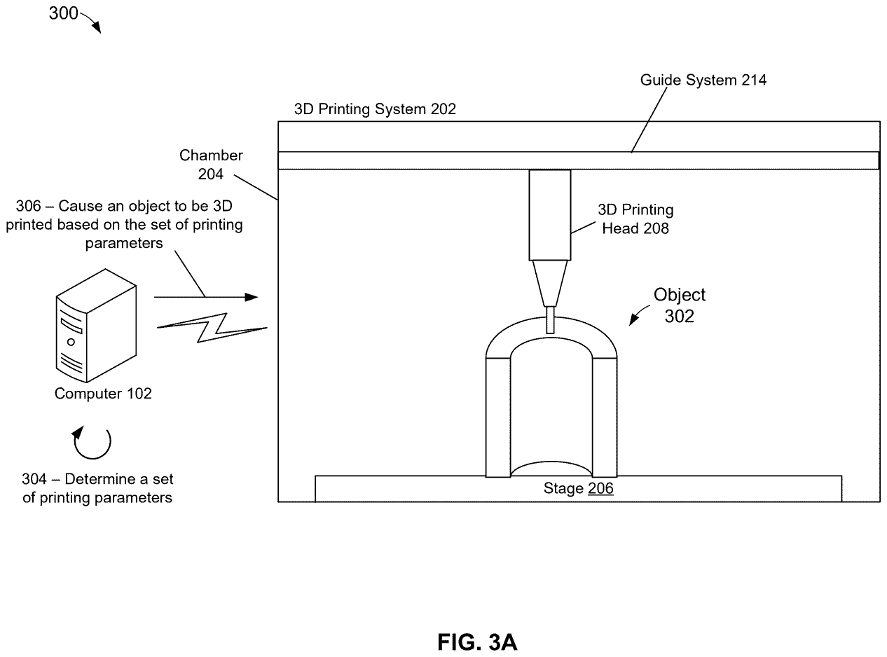

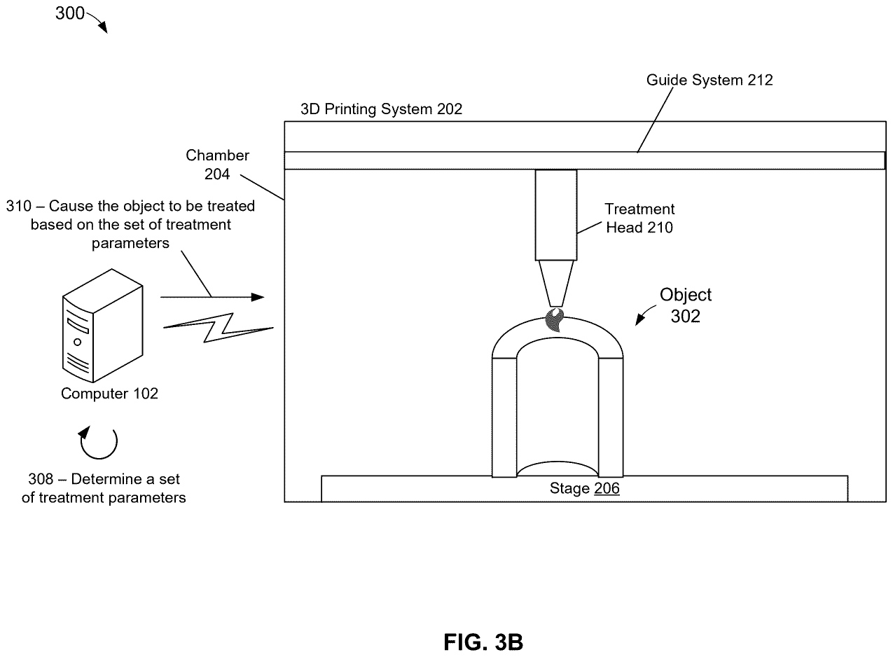

FIGS. 3A and 3B are diagrams of an example implementation 300 of 3D printing an object. As shown in FIGS. 3A and 3B, the 3D printing process may be performed to 3D print an object 302 using the 3D printing system 202. The object 302 is not limited to any particular type of object, and may include industrial components, consumer components, and/or other types of components.

As shown in FIG. 3A, at 304, the computer 102 may determine a set of printing parameters for 3D printing the object 302. The set of printing parameters may include a printing speed for a layer of the object 302, a movement path for the 3D printing head 208 for printing the layer, a material deposition rate for the 3D printing head 208, a power level (e.g., a laser power level) for the 3D printing head 208, and/or a type of material that is to be deposited, among other examples. In some implementations, one or more of the printing parameters is based on the shape, geometry, size, orientation, and/or complexity of the object 302 that is to be printed. For example, the printing speed may be based on the size of the object 302 and/or the shape of the object 302. As another example, the power level of the laser beam may be based on the type of material from which the object 302 is formed.

In some implementations, one or more of the printing parameters may be based on the types, magnitudes, directions, and/or other properties of stresses that are to be experienced by the object 302 during use or service of the object 302. The computer 102 may simulate the reactions of the object 302 to the stresses and may select one or more materials for manufacturing the object 302 by 3D printing based on the simulation. The computer 102 may select materials that satisfy design parameters for the object 302 (e.g., load requirements, reliability requirements, maintainability requirements) while achieving optimized cost, weight, service life, and/or manufacturing complexity for the object 302.

To perform the stress simulation, the computer 102 may receive a 3D model of the object 302 and a set of environmental and operational parameters for the object 302. The 3D model may be a digital representation of the object 302, and may represent the shape, geometry, and/or dimensions of the object 302. The environmental and operational parameters may include information identifying various environmental conditions that the object 302 is to experience in use, such as temperature ranges and profiles, vibration ranges and profiles, load ranges, contaminants, humidity, acids, water, and/or other types of environmental conditions. The environmental and operational parameters may also include information identifying various types of physical stresses that are to be exerted on the object 302 during use, such as tensile stresses, compressive stresses, shear stresses, bending stresses, torsional stresses, impact stresses, fatigue stresses, and/or other types of physical stresses. The environmental and operational parameters may also include information identifying boundary conditions for the object 302, such as fixed supports for the object 302, forces to be exerted on the object 302, displacements of the object 302, temperatures to be experienced by the object 302, dynamic loads to be experienced by the object 302, and/or other boundary conditions that simulate the interactions of the object 302 with its surroundings.

The computer 102 may perform stress simulation to model the impacts of the physical and environmental stresses on the object 302 using various candidate materials from a materials database to select one or more materials for the object 302 that can withstand the physical and environmental stresses that are to be experienced by the object 302. Accordingly, the stress simulation may be iterative in that the computer 102 iterates through a plurality of simulations for the candidate materials to determine outcomes for each of the candidate materials. Each stress simulation may include a thermal stress simulation (e.g., a thermal analysis of the thermal stresses) and a mechanical simulation (e.g., a finite element analysis (FEA) simulation for physical stresses) for each candidate material. The mechanical simulation may include such simulations as tensile stress simulation, compressive stress simulation, shear stress simulation, torsional stress simulation, bending stress simulation, residual stress simulation, hydrostatic stress simulation, fatigued stress simulation, and/or creep stress simulation, among other examples. The stress simulation may be performed to determine the stress distribution and deformation across the object 302 based on the environmental and operational parameters for each candidate material.

The material database may include information identifying various properties of the candidate materials, such as a material type for each candidate material, a density for each candidate material, a Young's modulus for each candidate material, a Poisson's ratio for each candidate material, a thermal conductivity for each candidate material, a stress limit for each candidate material, and/or other material properties.

The results of the stress simulation may include a stress contour plot for the object 302, deformation animations, and/or other simulation results. The computer 102 may classify the types of stresses experienced by the object 302 based on the calculated stress distribution, and the magnitudes of each type of stress at specific points along the object 302 may be determined.

In some implementations, the computer 102 may segment the 3D model of the object 302 into a plurality of regions based on the results of the stress simulation, and may select materials for each of the regions. In this way, different regions of the object 302 may be selected to be manufactured from different materials based on the stress simulation, which enables the strength, weight, rigidity, and/or other properties of these regions to be optimized for the environmental conditions that are to be experienced by the object 302. The computer 102 may select the portions based on the different types of stresses experienced by the object 302. For example, each portion may be a portion of the object 302 where a particular type of stress is predominate. As an example, the computer 102 may segment the object 302 into a region where tensile stress is highest, another region where bending stress is prevalent, and so on. As another example, the computer 102 may segment the object 302 into regions where the magnitudes of particular stress types satisfy thresholds, and therefore these regions may be regions of the object 302 where these particular stresses are considered to have a significant presence.

As further shown in FIG. 3A, at 306, the computer 102 may provide one or more signals to the 3D printing system 202 to cause the 3D printing system 202 to 3D print the 3D printed object 302. 3D printing the 3D printed object 302 may include dispensing or depositing material through the 3D printing head 208 onto the stage 206 to build up the 3D printed object 302 layer by layer. Additionally and/or alternatively, the stage 206 may include a powder fusion bed of material, and the 3D printing head 208 may emit a laser beam or ultraviolet (UV) radiation beam that is used to sinter or cure the material to build up the 3D printed object 302 layer by layer.

In some implementations, the computer 102 may the provide one or more signals to the 3D printing system 202 to cause the 3D printing system 202 to 3D print the layer of the 3D printed object 302 based on the set of printing parameters. For example, the signal(s) may cause the guide system 212 of the 3D printing system 202 to move the 3D printing head 208 along the movement path determined for the set of printing parameters. As another example, the signal(s) may cause the 3D printing head 208 to dispense material at a rate that was determined for the set of printing parameters. As another example, the signal(s) may cause the 3D printing head 208 to emit a laser beam at a power level that was determined for the set of printing parameters.

As another example, the signal(s) may cause the 3D printing head 208 to 3D print different regions of the object 302 from different materials based on the materials selected from the stress simulation (or the iterative stress simulation). For example, the 3D printing head 208 may 3D print a first region of the object 302 from a metal such as titanium and a second region of the object 302 from a polymer. As another example, the 3D printing head 208 may 3D print a first region of the object 302 from a first metal such as an aluminum alloy and a second region of the object 302 from a different metal such as a nickel-based superalloy.

As shown in FIG. 3B, at 308, the computer 102 may determine a set of treatment parameters for performing one or more material treatments on the object 302. The one or more material treatments may include surface hardening (e.g., flame hardening, case hardening), alloying, cold rolling, tempering, and/or another type of material treatment. The set of treatment parameters may include a material treatment type that is to be performed, a location on the object for performing the material treatment type, and/or another parameter. For a particular type of material treatment such as surface hardening, the set of treatment parameters may include a temperature for the surface hardening, a quenching speed, a duration for the surface hardening, and/or another parameter. In some implementations, different types of material treatments are performed for different regions of the object 302, and the set of treatment parameters includes material treatment parameters for each of the different regions of the object 302.

In some implementations, one or more of the treatment parameters may be based on the types, magnitudes, directions, and/or other properties of stresses that are to be experienced by the object 302 during use or service of the object 302. The computer 102 may simulate the reactions of the object 302 to the stresses and may select one or more material treatments for manufacturing the object 302 by 3D printing based on the simulation. The computer 102 may select material treatments that satisfy design parameters for the object 302 (e.g., load requirements, reliability requirements, maintainability requirements) while achieving optimized cost, weight, service life, and/or manufacturing complexity for the object 302.

To perform the stress simulation, the computer 102 may use the 3D model of the object 302 and the set of environmental and operational parameters for the object 302. The computer 102 may perform stress simulation to model the impacts of the physical and environmental stresses on the object 302 using various candidate material treatments from a material treatment database to select one or more material treatments for the object 302 that can withstand the physical and environmental stresses that are to be experienced by the object 302. Accordingly, the stress simulation may be iterative in that the computer 102 iterates through a plurality of simulations for the candidate material treatments to determine outcomes for each of the candidate material treatments. Each stress simulation may include a thermal stress simulation (e.g., a thermal analysis of the thermal stresses) and a mechanical simulation (e.g., an FEA simulation for physical stresses) for each candidate material treatment. The mechanical simulation may include such simulations as tensile stress simulation, compressive stress simulation, shear stress simulation, torsional stress simulation, bending stress simulation, residual stress simulation, hydrostatic stress simulation, fatigued stress simulation, and/or creep stress simulation, among other examples. The stress simulation may be performed to determine the stress distribution and deformation across the object 302 based on the environmental and operational parameters for each candidate material treatment.

The material treatment database may include information identifying various properties of the candidate material treatments, such as strengthening properties, temperature ranges, treatment effects, and/or other material treatment properties.

The results of the stress simulation may include a stress contour plot for the object 302, deformation animations, and/or other simulation results. The computer 102 may classify the types of stresses experienced by the object 302 based on the calculated stress distribution, and the magnitudes of each type of stress at specific points along the object 302 may be determined.

In some implementations, the computer 102 may segment the 3D model of the object 302 into a plurality of regions based on the results of the stress simulation, and may select material treatments for each of the regions. In this way, different regions of the object 302 may be selected to be manufactured from different material treatments based on the stress simulation, which enables the strength, weight, rigidity, and/or other properties of these regions to be optimized for the environmental conditions that are to be experienced by the object 302. The computer 102 may select the portions based on the different types of stresses experienced by the object 302. For example, each portion may be a portion of the object 302 where a particular type of stress is predominate. As an example, the computer 102 may segment the object 302 into a region where tensile stress is highest, another region where bending stress is prevalent, and so on. As another example, the computer 102 may segment the object 302 into regions where the magnitudes of particular stress types satisfy thresholds, and therefore these regions may be regions of the object 302 where these particular stresses are considered to have a significant presence.

As further shown in FIG. 3B, at 310, the computer 102 may provide one or more signals to the 3D printing system 202 to cause the 3D printing system 202 to perform one or more material treatments on the object 302 based on the set of treatment parameters. The one or more material treatments may be applied to the object 302 using the treatment head 210 of the 3D printing system 202. The signal(s) may cause the guide system 212 to position the treatment head 210 and/or to move the treatment head 210 along a particular path so that the material treatments are applied to the different regions of the object 302 based on the set of treatment parameters.

In some implementations, the computer 102 selects a combination of materials and material treatments for the different regions of the object 302 using an iterative tournament-style simulation that is based on the iterative stress simulation of the object 302. The tournament-style simulation may be a type of trial-and-error simulation where different combinations of materials and material treatments are tested against each other in a tournament-style bracket until one remaining combination is selected.

The testing bracket, be, models the most likely outcomes for the comparison of different combinations of materials and material treatments. The computer 102 generates the testing bracket from a tournament stress draw, dₜ, and all completed stress comparisons, m_{f}. The computer 102 uses a simulator to generate the testing bracket by determining the winning material and material treatment combination of each match using an Elo based Watson Power Index (stress index), wpi_{elo,p}. The simulator may be represented as:

bₑ(dₜ,m_{f})=simₜ(dₜ,m_{f})

The inputs for the simulator may include a round, cᵣ, the set of matches within the stress draw, dₜ, the finished matches, m_{f}, and/or the latest SPI for each player, wpi_{p,r}. The output from the simulator may include a populated testing bracket, bₑ, with predictions, Prₓ, for each match and WPI Elo for each player, wpi_{elo,px,r}.

Each candidate combination of a material and material treatment may have a Watson Power Index (WPI), wpiₚ, that has been computed by the computer 102. Throughout the testing bracket and as comparisons continue, an Elo based WPI, wpi_{elo,p,r}, may be determined for each combination. In the current round, the simulator may use the scaled WPI for each combination, swpiₚ, calculated based on:

$${swpi}_{p , r} = 1 \; 400 * ( \frac{log ( {wpi}_{p , r} ) + 5}{5} )$$

In all other rounds, the wpi_{elo,p1,r} may be updated according to equation:

$${wpi}_{elo , px , r} = {wpi}_{elo , px , r - 1} + k ( {t}_{{p}_{x} , {p}_{y}} - {Pr}_{x} ( {p}_{x} beats {p}_{y} ) ) ;$$

$$k ∈ [ 0 , 1 ] ; {t}_{{p}_{x} , {p}_{y}} = \{ 1 , 0 \} ;$$

$$k = \{ \begin{matrix}10 , & if wpi\_rank < 20 \\ 50 , & if wpi\_rank < 50 \\ 75 , & if wpi\_rank < 100 \\ 100 , & if wpi\_rank < 200\end{matrix}$$

The k factor determines how much a single comparison is weighted, while tₚ_{ₓ}_{,p}_{_{y}} is 1 if x beats y, or 0 otherwise.

The probability that a combination will be selected over another combination may be represented as:

$${Pr}_{x} ( {p}_{x} beats {p}_{y} ) = \frac{1}{1 + {10}^{\frac{- ( {wpi}_{elo , {p}_{x} , r} - {wpi}_{elo , {p}_{y} , r} )}{200}}}$$

$${p}_{x} ⋃ {p}_{y} = \{ p 1 , p 2 \}$$

Both of the WPI Elo values represent each combination's strength going into the next comparison.

With the testing bracket, bₑ, structure populated, each combination may have odds for being selected, selectₚ, which may be determined by the computer 102 according to:

$$P {r}_{select , x} = {\prod }_{m}^{{b}_{e}} \{ \begin{matrix}{Pr}_{x} ( {p}_{x} beats {p}_{y} ) ; {p}_{x} , {p}_{y} , & if {m}_{status} in - progress \\ 0.0001 , & if {m}_{status} completed and {p}_{x} = winner \\ {Pr}_{x} ( {p}_{x} beats {p}_{y} ) ; & if {m}_{status} completed and {p}_{x} \neq winner\end{matrix} ∈ m$$

Each of the Pr_{select,x} may have a difficulty category that maps to a specific ventile. The ventile determines the color coding of a combination x's odds of being selected. The bounds for each quantile, which is a ventile for the tournament, may be determined based on:

$${quantile}_{k} ( x ) = k if Pr ( X < x ) \leq \frac{k}{q} and Pr ( X \leq x ) \geq \frac{k}{q}$$

The computer 102 may determine the quantile, k, from the total quantile, q, based on the probability that a value, x, follows two probability bounds.

FIGS. 3A and 3B are provided as an example. Other examples may differ from what is described with regard to FIGS. 3A and 3B.

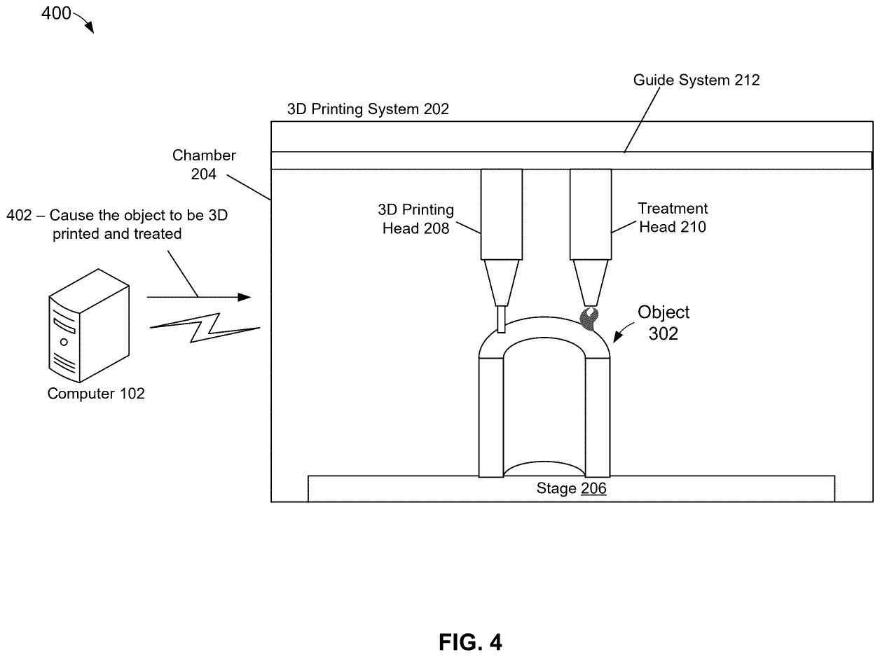

FIG. 4 is a diagram of an example implementation 400 of 3D printing an object. The example implementation 400 is similar to the example implementation 300, except that, at 402, the computer 102 may cause the 3D printing system 202 to simultaneously perform treatment of an object 302 while the object 302 is being simultaneously 3D printed.

In some implementations, the 3D printing system 202 may simultaneously treat the object 302 while the object 302 is 3D printed in a layer-by-layer manner. For example, a layer of the object 302 may be 3D printed and treated, another layer of the object 302 may be subsequently 3D printed and treated, and so on. A portion of a layer may be 3D printed by the 3D printing head 208 while a different portion of the layer may be treated by the treatment head 210.

The computer 102 may cause the guide system 212 to move the treatment head 210 and the 3D printing head 208 along paths that do not interfere with each other in order to achieve a high level of productivity for the 3D printing system 202. The 3D printing head 208 may print the layer without affecting the portion(s) where the treatment head 210 is applying treatment to the layer so that 3D printing productivity and treatment productivity can both be achieved together.

FIG. 4 is provided as an example. Other examples may differ from what is described with regard to FIG. 4.

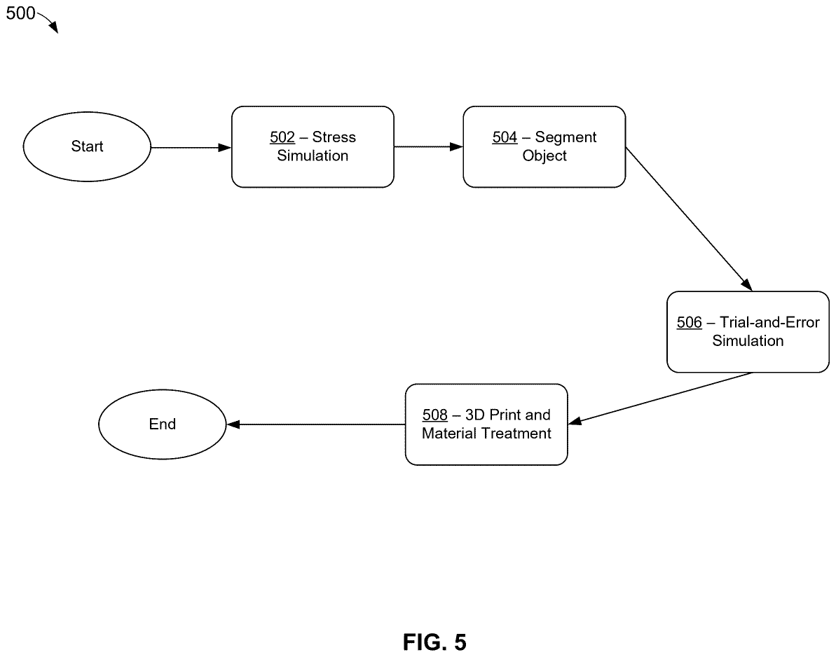

FIG. 5 is a diagram of an example implementation 500 of a 3D printing process for 3D printing an object. The 3D printing process may be performed by the computer 102 and the 3D printing system 202.

As shown in FIG. 5, at 502, the computer 102 may perform a stress simulation for the object (e.g., an object 302). The stress simulation may include modelling, using a 3D model of the object, various types of stresses that are to be exerted on the object during use or operation of the object.

As further shown in FIG. 5, at 504, the computer 102 may segment the object into a plurality of regions based on the stress simulation. The segmentation may be based on the stress types exerted on the object, the locations on the object of the stress types exerted on the object, the magnitudes for the stress types, and/or other parameters based on the stress simulation.

As further shown in FIG. 5, at 506, the computer 102 may perform a trial-and-error simulation using a plurality of candidate combinations of materials and material treatments for each of the regions of the object. The trial-and-error simulation may be performed to identify a combination of materials and material treatments for each region that satisfy various parameters, such as an estimated aggregated cost for the regions, an estimated aggregated weight for the regions, and/or a minimum service life for the object, among other examples. The trial-and-error simulation may be an iterative simulation in which the computer 102 iterates through the plurality of candidate combinations in a tournament-style selection process.

As further shown in FIG. 5, at 508, the computer 102 may cause the 3D printing system 202 to 3D print the object and perform one or more types of material treatment operations on the object based on a selected combination of materials and material treatments from the trial-and-error simulation.

FIG. 5 is provided as an example. Other examples may differ from what is described with regard to FIG. 5.

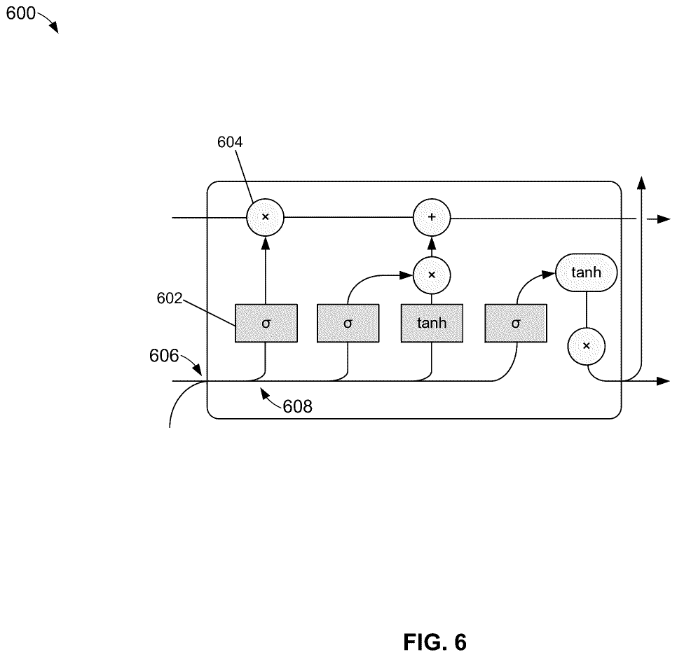

FIG. 6 is a diagram of an example implementation 600 of a long short-term memory model. The computer 102 may use the long short-term memory model as part of a trial-and-error simulation for selecting a combination of materials and material treatments for 3D printing an object.

As shown in FIG. 6, the long short-term memory model may be a type of recurrent neural network (RNN) architecture that is configured to identify long-term dependencies in sequential data. The long short-term memory model may include a combination of neural network layers 602, pointwise operations 604, concatenate operations 606, and copy operations 608, among other examples. The neural network layers 602 may include tanh activated neural network layers, sigmoid activated neural network layers, and/or another type of neural network layers. The pointwise operations 604 may include pointwise multiplication operations, pointwise addition operations, pointwise tanh operations, and/or other types of pointwise operations.

The long short-term memory model may include additional components such as a cell state, a hidden state, and one or more types of gates (e.g., an input gate, a forget gate, an output gate). The cell state is a memory that carries information across different time steps. The cell state enables the long short-term memory model to maintain long-term dependencies.

The gates regulate the flow of information into and out of the long short-term memory model. The forget gate determines what information to discard from the cell state. The cell forget gate takes the previous hidden state and the current input and passes them through a sigmoid function, which outputs a value between 0 and 1 for each number in the cell state. A value of 0 means “completely forget” and a value of 1 means “completely keep.”

The input gate determines what new information to add to the cell state. The input gate may consist of two parts, including a sigmoid layer that decides which values to update, and a tanh layer that creates a vector of new candidate values. These parts may correspond to the neural network layers 602. The output of these two layers is combined to update the cell state.

The output gate determines what information to output from the long short-term memory model. It takes the previous hidden state and the current input and passes them through a sigmoid function of a neural network layer 602. The output is then multiplied by the tanh of the cell state (e.g., in a pointwise operation 604) to produce the new hidden state.

The cell state may be updated by combining the information from the forget gate and the input gate. The forget gate determines which information to discard, while the input gate determines which new information to add. This enables the long short-term memory model to retain relevant information and discard irrelevant information over long sequences.

The output of the long short-term memory model may be generated by passing the updated cell state through the output gate. The output gate determines which parts of the cell state to output, and this output becomes the hidden state for the next time step.

By using the gates and the cell state, the long short-term memory model can effectively capture long-term dependencies and maintain information over long sequences. A computer 102 may use the long short-term memory model to monitor properties about candidate materials over time for material selection and material treatment of objects that are to be 3D printed. The output from the long short-term memory model, if closer to 1, may indicate that a candidate material is better suited for a specific region of an object, whereas an output closer to 0 indicates that the candidate material is not well suited for the specific region.

FIG. 6 is provided as an example. Other examples may differ from what is described with regard to FIG. 6.

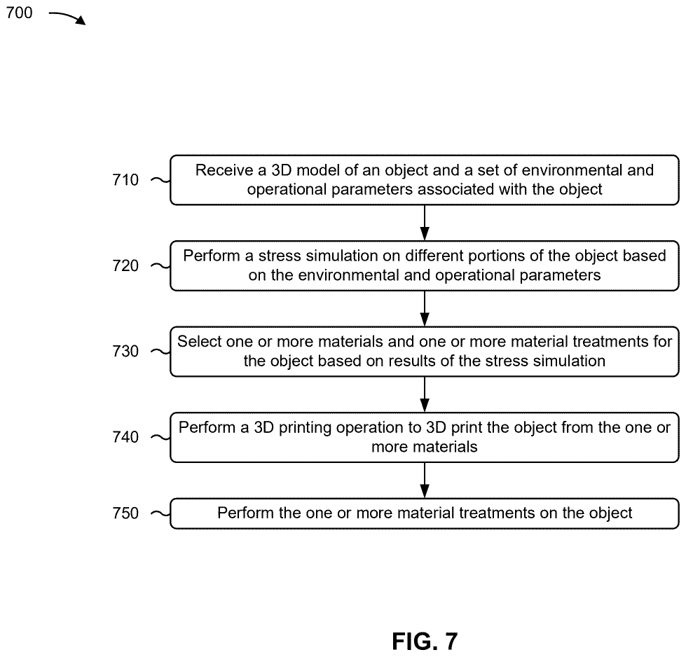

FIG. 7 is a flowchart of an example process 700 associated with integrated 3D printing, material selection, and treatment. One or more process blocks of FIG. 7 are performed by a 3D printing system (e.g., 3D printing system 202) and/or by another device or a group of devices separate from or including the 3D printing system, such as the computer 102. Additionally, or alternatively, one or more process blocks of FIG. 7 may be performed by one or more components of the computer 102, such as the processor set 114, the communication fabric 116, the volatile memory 118, the persistent storage 120, the peripheral device set 122, and/or the network module 124, among other examples. In some implementations, the processor set 114 of the computer 102 executes the 3D printing code 150 to perform one or more of the process blocks of FIG. 7.

As shown in FIG. 7, process 700 includes receiving a 3D model of an object and a set of environmental and operational parameters associated with the object (block 710). For example, the 3D printing system (and/or the computer 102) may receive a 3D model of an object and a set of environmental and operational parameters associated with the object, as described herein.

As further shown in FIG. 7, process 700 includes performing a stress simulation on different portions of the object based on the environmental and operational parameters (block 720). For example, the 3D printing system (and/or the computer 102) may perform a stress simulation on different portions of the object based on the environmental and operational parameters, as described herein.

As further shown in FIG. 7, process 700 includes selecting one or more materials and one or more material treatments for the object based on results of the stress simulation (block 730). For example, the 3D printing system (and/or the computer 102) may select one or more materials and one or more material treatments for the object based on results of the stress simulation, as described herein.

As further shown in FIG. 7, process 700 includes performing a 3D printing operation to 3D print the object from the one or more materials (block 740). For example, the 3D printing system may perform a 3D printing operation to 3D print the object from the one or more materials, as described herein.

As further shown in FIG. 7, process 700 includes performing the one or more material treatments on the object (block 750). For example, the 3D printing system may perform the one or more material treatments on the object, as described herein.

Process 700 may include additional aspects, such as any single aspect or any combination of aspects described below and/or in connection with one or more other processes described elsewhere herein.

In a first aspect, performing the stress simulation includes simulating at least one of tensile stress, compressive stress, shear stress, bending stress, torsional stress, or thermal stress on the object based on the set of environmental and operational parameters.

In a second aspect, alone or in combination with the first aspect, process 700 includes segmenting the 3D model of the object into a plurality of regions based on the results of the stress simulation.

In a third aspect, alone or in combination with one or more of the first and second aspects, each region, of the plurality of regions, is associated with a specific type and magnitude of stress.

In a fourth aspect, alone or in combination with one or more of the first through third aspects, selecting the one or more materials and the one or more material treatments includes selecting respective materials for each region of the plurality of regions.

In a fifth aspect, alone or in combination with one or more of the first through fourth aspects, selecting the one or more materials and the one or more material treatments includes selecting respective material treatments for each region of the plurality of regions.

In a sixth aspect, alone or in combination with one or more of the first through fifth aspects, selecting the one or more materials and the one or more material treatments includes selecting the one or more materials and the one or more material treatments based on at least one of an estimated aggregated cost for a plurality of regions the object, an estimated aggregated weight for the plurality of regions the object, or a minimum service life of the object.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

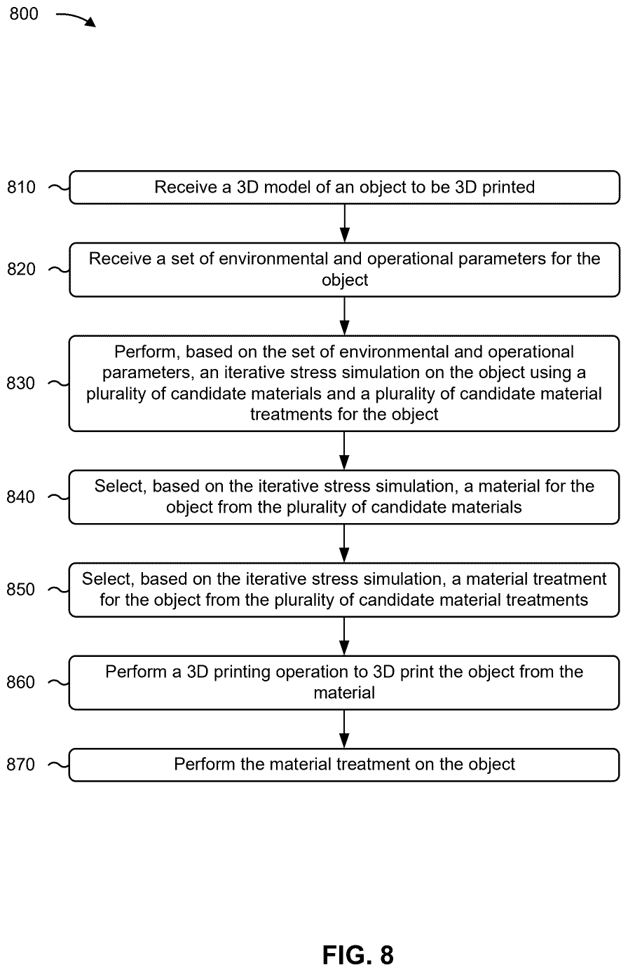

FIG. 8 is a flowchart of an example process 800 associated with integrated 3D printing, material selection, and treatment. One or more process blocks of FIG. 8 are performed by a 3D printing system (e.g., 3D printing system 202) and/or by another device or a group of devices separate from or including the 3D printing system, such as the computer 102. Additionally, or alternatively, one or more process blocks of FIG. 8 may be performed by one or more components of the computer 102, such as the processor set 114, the communication fabric 116, the volatile memory 118, the persistent storage 120, the peripheral device set 122, and/or the network module 124, among other examples. In some implementations, the processor set 114 of the computer 102 executes the 3D printing code 150 to perform one or more of the process blocks of FIG. 8.

As shown in FIG. 8, process 800 includes receiving a 3D model of an object to be 3D printed (block 810). For example, the 3D printing system (and/or the computer 102) may receive a 3D model of an object to be 3D printed, as described herein.

As further shown in FIG. 8, process 800 includes receiving a set of environmental and operational parameters for the object (block 820). For example, the 3D printing system (and/or the computer 102) may receive a set of environmental and operational parameters for the object, as described herein.

As further shown in FIG. 8, process 800 includes performing, based on the set of environmental and operational parameters, an iterative stress simulation on the object using a plurality of candidate materials and a plurality of candidate material treatments for the object (block 830). For example, the 3D printing system (and/or the computer 102) may perform, based on the set of environmental and operational parameters, an iterative stress simulation on the object using a plurality of candidate materials and a plurality of candidate material treatments for the object, as described herein.

As further shown in FIG. 8, process 800 includes selecting, based on the iterative stress simulation, a material for the object from the plurality of candidate materials (block 840). For example, the 3D printing system (and/or the computer 102) may select, based on the iterative stress simulation, a material for the object from the plurality of candidate materials, as described herein.

As further shown in FIG. 8, process 800 includes selecting, based on the iterative stress simulation, a material treatment for the object from the plurality of candidate material treatments (block 850). For example, the 3D printing system (and/or the computer 102) may select, based on the iterative stress simulation, a material treatment for the object from the plurality of candidate material treatments, as described herein.

As further shown in FIG. 8, process 800 includes performing a 3D printing operation to 3D print the object from the material (block 860). For example, the 3D printing system may perform a 3D printing operation to 3D print the object from the material, as described herein.

As further shown in FIG. 8, process 800 includes performing the material treatment on the object (block 870). For example, the 3D printing system may perform the material treatment on the object, as described herein.

Process 800 may include additional aspects, such as any single aspect or any combination of aspects described below and/or in connection with one or more other processes described elsewhere herein.

In a first aspect, performing the iterative stress simulation includes at least one of performing a plurality of tensile stress simulations using the plurality of candidate materials and the plurality of candidate material treatments for the object, performing a plurality of compressive stress simulations using the plurality of candidate materials and the plurality of candidate material treatments for the object, performing a plurality of shear stress simulations using the plurality of candidate materials and the plurality of candidate material treatments for the object, performing a plurality of torsional stress simulations using the plurality of candidate materials and the plurality of candidate material treatments for the object, or performing a plurality of bending stress simulations using the plurality of candidate materials and the plurality of candidate material treatments for the object.

In a second aspect, alone or in combination with the first aspect, performing the iterative stress simulation includes at least one of performing a plurality of thermal stress simulations using the plurality of candidate materials and the plurality of candidate material treatments for the object, performing a plurality of residual stress simulations using the plurality of candidate materials and the plurality of candidate material treatments for the object, performing a plurality of hydrostatic stress simulations using the plurality of candidate materials and the plurality of candidate material treatments for the object, performing a plurality of fatigue stress simulations using the plurality of candidate materials and the plurality of candidate material treatments for the object, or performing a plurality of creep stress simulations using the plurality of candidate materials and the plurality of candidate material treatments for the object.

In a third aspect, alone or in combination with one or more of the first and second aspects, selecting the material includes selecting the material based on one or more parameters for the material, where the one or more parameters for the material include at least one of a material type for the material, a density for the material, a Young's modulus for the material, a Poisson's ratio for the material, a thermal conductivity for the material, or a stress limit for the material.

In a fourth aspect, alone or in combination with one or more of the first through third aspects, performing the iterative stress simulation includes at least one of performing a plurality of FEA simulations using the plurality of candidate materials and the plurality of candidate material treatments for the object.

In a fifth aspect, alone or in combination with one or more of the first through fourth aspects, selecting the material and selecting the material treatment include performing, based on the iterative stress simulation, an iterative tournament-style simulation with a plurality of combinations of the plurality of candidate materials and the plurality of candidate material treatments to select the material and the material treatment from the plurality of combinations.

In a sixth aspect, alone or in combination with one or more of the first through fifth aspects, selecting the material and selecting the material treatment include selecting, based on the iterative tournament-style simulation, the material and the material treatment based on at least one of an estimated aggregated cost for the object, an estimated aggregated weight for the object, or a minimum service life of the object.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

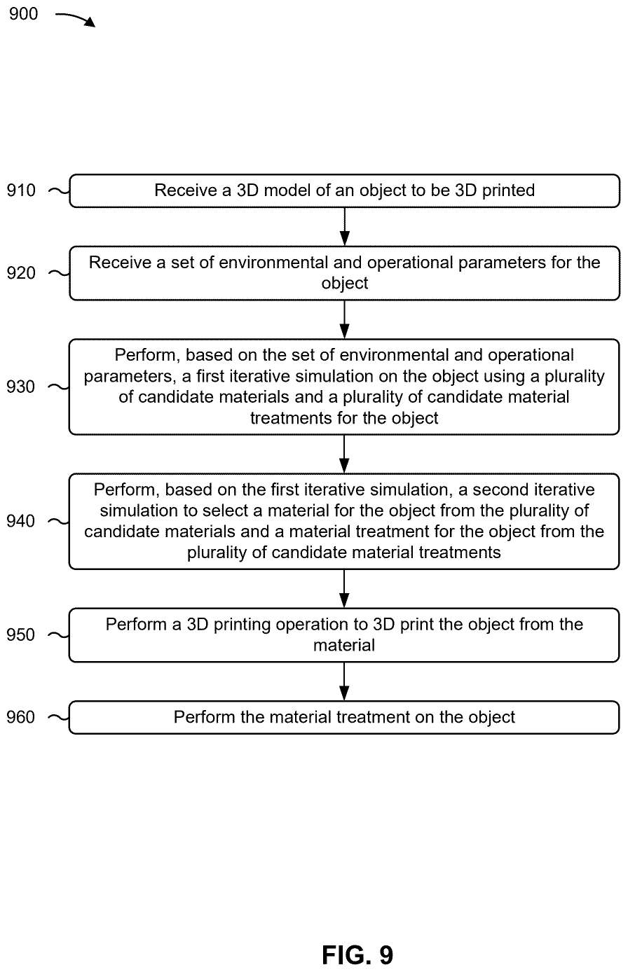

FIG. 9 is a flowchart of an example process 900 associated with integrated 3D printing, material selection, and treatment. One or more process blocks of FIG. 9 are performed by a 3D printing system (e.g., 3D printing system 202) and/or by another device or a group of devices separate from or including the 3D printing system, such as the computer 102. Additionally, or alternatively, one or more process blocks of FIG. 9 may be performed by one or more components of the computer 102, such as the processor set 114, the communication fabric 116, the volatile memory 118, the persistent storage 120, the peripheral device set 122, and/or the network module 124, among other examples. In some implementations, the processor set 114 of the computer 102 executes the 3D printing code 150 to perform one or more of the process blocks of FIG. 9.

As shown in FIG. 9, process 900 includes receiving a 3D model of an object to be 3D printed (block 910). For example, the 3D printing system (and/or the computer 102) may receive a 3D model of an object to be 3D printed, as described herein.

As further shown in FIG. 9, process 900 includes receiving a set of environmental and operational parameters for the object (block 920). For example, the 3D printing system (and/or the computer 102) may receive a set of environmental and operational parameters for the object, as described herein.

As further shown in FIG. 9, process 900 includes performing, based on the set of environmental and operational parameters, a first iterative simulation on the object using a plurality of candidate materials and a plurality of candidate material treatments for the object (block 930). For example, the 3D printing system (and/or the computer 102) may perform, based on the set of environmental and operational parameters, a first iterative simulation on the object using a plurality of candidate materials and a plurality of candidate material treatments for the object, as described herein.

As further shown in FIG. 9, process 900 includes performing, based on the first iterative simulation, a second iterative simulation to select a material for the object from the plurality of candidate materials and a material treatment for the object from the plurality of candidate material treatments (block 940). For example, the 3D printing system (and/or the computer 102) may perform, based on the first iterative simulation, a second iterative simulation to select a material for the object from the plurality of candidate materials and a material treatment for the object from the plurality of candidate material treatments, as described herein.

As further shown in FIG. 9, process 900 includes performing a 3D printing operation to 3D print the object from the material (block 950). For example, the 3D printing system may perform a 3D printing operation to 3D print the object from the material, as described herein.

As further shown in FIG. 9, process 900 includes performing the material treatment on the object (block 960). For example, the 3D printing system may perform the material treatment on the object, as described herein.

Process 900 may include additional aspects, such as any single aspect or any combination of aspects described below and/or in connection with one or more other processes described elsewhere herein.

In a first aspect, performing the 3D printing operation and performing the material treatment include simultaneously performing the 3D printing operation and the material treatment.

In a second aspect, alone or in combination with the first aspect, performing the 3D printing operation and performing the material treatment include performing the 3D printing operation, and performing the material treatment after the 3D printing operation.

In a third aspect, alone or in combination with one or more of the first and second aspects, performing the second iterative simulation includes performing the second iterative simulation using a long short-term memory model.

In a fourth aspect, alone or in combination with one or more of the first through third aspects, the operations include segmenting, based on the first iterative simulation, the 3D model of the object into a plurality of regions, where performing the second iterative simulation includes performing the second iterative simulation on each of the plurality of regions to select respective materials, from the plurality of candidate materials, and respective material treatments, from the plurality of candidate material treatments, for the plurality of regions.

In a fifth aspect, alone or in combination with one or more of the first through fourth aspects, the first iterative simulation includes an iterative stress simulation, and the second iterative simulation includes an iterative tournament-style selection simulation.

Although FIG. 9 shows example blocks of process 900, in some implementations, process 900 includes additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving a three-dimensional (3D) model of an object and a set of environmental and operational parameters associated with the object;
performing a stress simulation on different portions of the object based on the environmental and operational parameters;
selecting one or more materials and one or more material treatments for the object based on results of the stress simulation;
performing a 3D printing operation to 3D print the object from the one or more materials; and
performing the one or more material treatments on the object.

2. The method of claim 1, wherein performing the stress simulation comprises:
simulating at least one of tensile stress, compressive stress, shear stress, bending stress, torsional stress, or thermal stress on the object based on the set of environmental and operational parameters.

3. The method of claim 1, further comprising:
segmenting the 3D model of the object into a plurality of regions based on the results of the stress simulation.

4. The method of claim 3, wherein each region, of the plurality of regions, is associated with a specific type and magnitude of stress.

5. The method of claim 3, wherein the selecting the one or more materials and the one or more material treatments comprises:
selecting respective materials for each region of the plurality of regions.

6. The method of claim 3, wherein the selecting the one or more materials and the one or more material treatments comprises:
selecting respective material treatments for each region of the plurality of regions.

7. The method of claim 1, wherein the selecting the one or more materials and the one or more material treatments comprises:
selecting the one or more materials and the one or more material treatments based on at least one of:
an estimated aggregated cost for a plurality of regions the object,
an estimated aggregated weight for the plurality of regions the object, or
a minimum service life of the object.

8. A computer system comprising:
a processor set,
one or more computer-readable storage media, and
program instructions stored on the one or more computer-readable storage media to cause the processor set to perform operations comprising:
receiving a three-dimensional (3D) model of an object to be 3D printed;
receiving a set of environmental and operational parameters for the object;
performing, based on the set of environmental and operational parameters, an iterative stress simulation on the object using a plurality of candidate materials and a plurality of candidate material treatments for the object,
selecting, based on the iterative stress simulation, a material for the object from the plurality of candidate materials;
selecting, based on the iterative stress simulation, a material treatment for the object from the plurality of candidate material treatments;
performing a 3D printing operation to 3D print the object from the material; and
performing the material treatment on the object.

9. The computer system of claim 8, wherein performing the iterative stress simulation comprises at least one of:
performing a plurality of tensile stress simulations using the plurality of candidate materials and the plurality of candidate material treatments for the object,
performing a plurality of compressive stress simulations using the plurality of candidate materials and the plurality of candidate material treatments for the object,
performing a plurality of shear stress simulations using the plurality of candidate materials and the plurality of candidate material treatments for the object,
performing a plurality of torsional stress simulations using the plurality of candidate materials and the plurality of candidate material treatments for the object, or
performing a plurality of bending stress simulations using the plurality of candidate materials and the plurality of candidate material treatments for the object.

10. The computer system of claim 8, wherein performing the iterative stress simulation comprises at least one of:
performing a plurality of thermal stress simulations using the plurality of candidate materials and the plurality of candidate material treatments for the object,
performing a plurality of residual stress simulations using the plurality of candidate materials and the plurality of candidate material treatments for the object,
performing a plurality of hydrostatic stress simulations using the plurality of candidate materials and the plurality of candidate material treatments for the object,
performing a plurality of fatigue stress simulations using the plurality of candidate materials and the plurality of candidate material treatments for the object, or
performing a plurality of creep stress simulations using the plurality of candidate materials and the plurality of candidate material treatments for the object.

11. The computer system of claim 8, wherein selecting the material comprises:
selecting the material based on one or more parameters for the material,
wherein the one or more parameters for the material comprise at least one of:
a material type for the material,
a density for the material,
a Young's modulus for the material,
a Poisson's ratio for the material,
a thermal conductivity for the material, or
a stress limit for the material.

12. The computer system of claim 8, wherein performing the iterative stress simulation comprises at least one of:
performing a plurality of finite element analysis (FEA) simulations using the plurality of candidate materials and the plurality of candidate material treatments for the object.

13. The computer system of claim 8, wherein selecting the material and selecting the material treatment comprise:
performing, based on the iterative stress simulation, an iterative tournament-style simulation with a plurality of combinations of the plurality of candidate materials and the plurality of candidate material treatments to select the material and the material treatment from the plurality of combinations.

14. The computer system of claim 13, wherein selecting the material and selecting the material treatment comprise:
selecting, based on the iterative tournament-style simulation, the material and the material treatment based on at least one of:
an estimated aggregated cost for the object,
an estimated aggregated weight for the object, or
a minimum service life of the object.

15. A computer program product comprising:
one or more computer-readable storage media, and
program instructions stored on the one or more computer-readable storage media to perform operations comprising:
receiving a three-dimensional (3D) model of an object to be 3D printed;
receiving a set of environmental and operational parameters for the object;
performing, based on the set of environmental and operational parameters, a first iterative simulation on the object using a plurality of candidate materials and a plurality of candidate material treatments for the object,
performing, based on the first iterative simulation, a second iterative simulation to select a material for the object from the plurality of candidate materials and a material treatment for the object from the plurality of candidate material treatments;
performing a 3D printing operation to 3D print the object from the material; and
performing the material treatment on the object.

16. The computer program product of claim 15, wherein performing the 3D printing operation and performing the material treatment comprise:
simultaneously performing the 3D printing operation and the material treatment.

17. The computer program product of claim 15, wherein performing the 3D printing operation and performing the material treatment comprise:
performing the 3D printing operation; and
performing the material treatment after the 3D printing operation.

18. The computer program product of claim 15, wherein performing the second iterative simulation comprises:
performing the second iterative simulation using a long short-term memory (LSTM) model.

19. The computer program product of claim 15, wherein the operations comprise:
segmenting, based on the first iterative simulation, the 3D model of the object into a plurality of regions,
wherein performing the second iterative simulation comprises:
performing the second iterative simulation on each of the plurality of regions to select respective materials, from the plurality of candidate materials, and respective material treatments, from the plurality of candidate material treatments, for the plurality of regions.

20. The computer program product of claim 15, wherein the first iterative simulation comprises an iterative stress simulation; and
wherein the second iterative simulation comprises an iterative tournament-style selection simulation.
